(19) United States
(12) Patent Application Publication
(10) Pub. No.: US 2007/0254109 A1
(43) Pub. Date: Nov. 1, 2007

(54) COATINGS, COATING FORMULATIONS, AND COMPOSITIONS CONTAINING QUATERNARY AMMONIUM COMPOUNDS

(75) Inventors: Joe D. Sauer, Baton Rouge, LA (US); George W. Cook, Baton Rouge, LA (US); Edmund F. Perkins, Baton Rouge, LA (US); Christopher S. Knight, Prairieville, LA (US)

Correspondence Address: EDGAR SPIELMAN;ALBEMARLE CORPORATION, 451 FLORIDA BLVD., BATON ROUGE, LA, 70801, US

(73) Assignee: Albemarle Corporation, Baton Rouge, LA (US)

(21) Appl. No.: 11/738,747

(22) Filed: Apr. 23, 2007

Related U.S. Application Data
(60) Provisional application No. 60/795,694, filed on Apr. 28, 2006.
(60) Provisional application No. 60/838,212, filed on Aug. 17, 2006.

(51) Int. Cl. B05D 1/02; C09D 5/14; C09D 5/16; B05D 1/28; B05D 1/18; B05D 3/00; B05D 1/30

(52) U.S. Cl. 427/420; 427/294; 427/428.01; 427/430.1; 427/421.1

(57) ABSTRACT

The present invention relates to compositions, coatings, coating formulations, etc., containing quaternary ammonium compounds and their use.

### REFERENCE To RELATED APPLICATIONS

This application claims priority to U.S. Provisional Patent Application Nos. 60/795,694 filed 28 Apr. 2006 and 60/838,212 filed 17 Aug. 2006, the disclosure of each is herein incorporated by reference in its entirety.

### FIELD OF THE INVENTION

The present invention relates to compositions, coating formulations, and coatings containing quaternary ammonium compounds, and the use of the same.

### BACKGROUND OF THE INVENTION

A class of molecules referred to as quaternary compounds or “quats” for short find use in many industrial applications. Quats are loosely defined as a group of compounds generally having the formula R₁R₂R₃R₄—N⁺X⁻, where the radicals may be the same, different, or part of a ring and X is a counter anion. Typically, but not always, one of the radicals is a long-chain alkyl group. In most industrial applications, these quat molecules are complexed with a counter ion (anion) to provide for an “active” molecule. Currently, quats are used in industries ranging from the wood preservative/biocide industry to such industries as hair care products, cleaning products, fabric softeners, pharmaceuticals, surfactants, deodorants, mouthwashes, preservatives, emulsifiers, cosmetics, and ore mining.

In the paint and coatings industry, it is common practice to use additives that provide desired characteristics. Some of the most common additives used impart mildew resistance, better flow characteristics, pleasant odors, etc. to the final formulation. Also, in the marine paint and coating industry, it is common to use anti-fouling additives that prevent the growth of microorganisms, algae, barnacles, and other marine life on objects to which the coating has been applied such as, for example, drilling platforms, piping, hulls, etc, for example see U.S. Pat. Nos. 7,001,933 and 4,675,051 and GB-A-2 273 934.

However even with the currently available additives, there is still a need for environmentally friendly, effective paint and coating additives.

### SUMMARY OF THE INVENTION

The present invention relates to a composition comprising at least one quaternary ammonium compound having the formula:

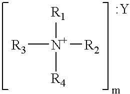

wherein:
i) said composition is metal coupler free;
ii) Y is selected from H₂BO₃⁻; HBO₃⁻²; BO₃⁻³; B₄O₇⁻²; HB₄O₇⁻; B₃O₅⁻; B₅O ₈⁻²; BO₂⁻; PO₄⁻³, HPO₄⁻², H₂PO₄⁻, P₂O₇⁻⁴, P₃P₁₀⁻⁵, PO₃⁻; CO₃⁻²; HCO₃⁻; [CO₂⁻]ₙR₅; and combinations thereof;
iii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iv) at least two of R₁, R₂, R₃ and R₄ are independently chosen from alkyl groups having from 1 to 4 carbon atoms;
v) at least one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
vi) n is an integer equal to or greater than 1 and R₅ is chosen from substituted, unsubstituted, saturated, or unsaturated alkyl groups containing from 1 to 25 carbon atoms; and
vii) m is 1, 2, 3, 4, or 5 depending on the selection of Y.

In one embodiment, the present invention relates to a solution comprising:
a) at least one quaternary ammonium compound having the formula:

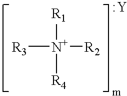

wherein:
i) Y is selected from H₂BO₃⁻; HBO₃⁻²; BO₃⁻³; B₄O₇⁻²; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻, CO₃⁻²; HCO₃⁻; [CO₂⁻]ₙR₅; and combinations thereof;
ii) at least two of R₁, R₂, R₃ and R₄ are independently chosen from alkyl groups having from 1 to 4 carbon atoms;
iii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iv) n is an integer equal to or greater than 1 and R₅ is chosen from substituted, unsubstituted, saturated, or unsaturated alkyl groups containing from 1 to 25 carbon atoms; and
v) m is 1, 2, 3, 4, or 5 depending on the selection of Y;
   and,
b) as a solvent for the quaternary ammonium compound of a), water and at least one polar organic co-solvent.
   wherein said solution is metal coupler free.

In another embodiment, the present invention relates to a solution comprising:
a) a quaternary ammonium compound having the formula:

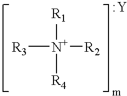

wherein:
i) Y is selected from H₂BO₃⁻; HBO₃⁻²; BO₃⁻³; B₄O₇⁻²; HB₄O₅⁻; B₅O₈⁻²; BO₂⁻; and mixtures thereof
ii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) m is 1, 2, or 3, depending on the selection of Y;
b) a quaternary ammonium compound having the formula:

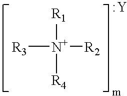

wherein:
i) Y is selected from CO₃⁻²; HCO₃⁻; PO₄⁻³, HPO₄⁻², H₂PO₄⁻, P₂P₇⁻⁴, P₃O₁₀⁻⁵, PO₃⁻; [CO₂³¹ ]ₙR₅; and mixtures thereof
ii) R₁, R₂, R₃ and R₄ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups;
iii) n is an integer equal to or greater than 1 and R₅ is chosen from substituted, unsubstituted, saturated or unsaturated alkyl groups containing from 1 to 25 carbon atoms; and
iv) m is 1, 2, 3, 4, or 5;
   and
c) a solvent for a) and b),
   wherein said solution is metal coupler free.

### DETAILED DESCRIPTION OF THE INVENTION

It should be noted that the term “quaternary ammonium compound”, “quat”, and “borate-quat” as used herein refers to a compound in which at least one nitrogen atom is joined to four organic radicals leaving a net positive charge. In certain aspects, the organic radicals can be alkyl or alkenyl (unsaturated alkyls) groups that are linear or branched, substituted or unsubstituted, or mixtures thereof. In other aspects, the term “quaternary ammonium compound” or “quat” is also intended to encompass a compound in which more than one nitrogen is joined to four organic radicals. For example, one of the four organic radicals of a quat may be a “shared” radical with a second quat.

In one embodiment, the present invention relates to a coating formulation. It should be noted that “coating formulation” as used herein is to be given its broadest meaning and is meant to encompass not only conventional paints and primers but also base coats, clear coats, lacquers, etc. that are commonly applied to surfaces. The coating formulation of the present invention can be either a water-based formulation or a solvent-based formulation, and it comprises at least a binder and a quaternary ammonium compound having the formula described herein.

The inventors hereof have discovered that the use of the quaternary ammonium compounds described herein in coating formulations can impart to the coating formulation, at least one of, preferably at least two of, more preferably substantially all of, the following properties: i) fungicidal properties, ii) mildewcidal properties, iii) biocidal properties, and iv) properties that prevent or inhibit the growth of marine life such as algae, barnacles, etc. Further, the use of quaternary ammonium compounds to provide these properties provides the end user of the coating formulation with great control over the method by which the coating formulation provides these properties.

It should also be noted that the phrase “metal coupler free” is sometimes used herein to describe the quaternary ammonium compounds, compositions, coatings, coating formulations, etc., of the present invention. By metal coupler free, it is meant that the quats themselves and compositions, coatings, coating formulations, etc., containing the same do contain copper, zinc, or other heavy metals commonly used in the preservative industry. These metals are commonly used for their biocidal and termiticide properties, as taught in Findlay. However, with growing environmental concerns, the industry is moving away from using these and other “heavy” metals.

### Binder

The selection of the binder is made accordingly to the end use and desired qualities of the coating formulation. For example, the coating formulation of the present invention can be designed wherein the quaternary ammonium compound is incorporated into the binder component providing a coating formulation wherein the quaternary ammonium compound remains in the coating formulation for the life of the coating formulation, or the coating formulation can be designed to be an ablative exterior coating that will intentionally be weathered away and subsequently replaced from time to time. The incorporation of the quaternary ammonium compound to form a coating formulation having either of the above characteristics is readily achievable by one having ordinary skill in the art.

Binders suitable for use in the present invention are generally selected from i) linseed oil, ii) polyurethane, iii) polyvinyl acetate, or iv) resins such as alkyd, acrylic, or epoxy resins. Non-limiting examples of resins suitable in coating formulations according to the present invention include those selected from acrylic polymers, modified acrylic polymers, polyepoxides, polyesters, polycarbonates, polyurethanes, polyamides, polyimides, polysiloxanes, polycarbamates and mixtures thereof, and the molecular weight of the resin not critical to the present invention. The binder can also be selected from any of those water-soluble resins listed in Flick, E. W. (1991). Water-Soluble Resins—An Industrial Guide (2nd Edition). William Andrew Publishing/Noyes, which is incorporated herein in its entirety by reference.

If the binder chosen is a resin, the resin can, and in some embodiments does, include reactive functional groups such as, for examples, carboxyl, hydroxyl, epoxy, amino, alkylamino, multi-functional amine, amido, silane, silanol and keto groups or combinations thereof. The degree of substitution of the reactive functional groups is not critical, but rather can be adjusted to provide a coating having desired characteristics. Further, it is within the scope of the present invention that the resin is a self-crosslinking or U.V. curable, and these polymers can be readily made by one having ordinary skill in the art or bought commercially from one of the many suppliers of such polymers.

Where acrylic polymers are utilized as the binder in the present invention, such polymers can be prepared from monomers such as acrylic acid and methacrylic acid, alkyl and cycloalkyl acrylates and methacrylates having in the range of from 1 to 18, preferably in the range of from 4 to 13, carbon atoms in the alkyl or cycloalkyl moiety, or mixtures of such monomers, by way of non-limiting example. Non-limiting examples of these include methyl acrylate, methyl methacrylate, ethyl acrylate, ethyl methacrylate, n-butyl acrylate, isobutyl acrylate, tertiary butyl acrylate, n-butyl methacrylate, 2-ethylhexyl acrylate, cyclohexyl methacrylate, and 2-ethylhexyl methacrylate.

If the acrylate polymer includes a functional group, the functional group can suitably be incorporated into the acrylic polymer by reacting functional monomers, such as those having, for example, carboxyl, hydroxyl, epoxy, amino, keto, silane, silanol, and alkylamino functional groups, by way of non-limiting example. Non-limiting examples of carboxyl containing monomers include acrylic acid, methacrylic acid, crotonic acid, itaconic acid, maleic acid, fumaric acid, 2-acryloxymethoxy-O-phthalic acid, 2-acryloxy-1-methylethoxy-O-hexahydrophthalic acid. Hydroxy functional monomers include 2-hydroxylethyl acrylate, 2-hydroxyethyl methacrylate, hydroxypropyl methacrylate, hydroxy butyl acrylate, hydroxybutyl methacrylate, allyl alcohol, and methallyl alcohol. A non-limiting example of an epoxy functional monomer includes glycidyl methacrylate. Non-limiting examples of alkylamino acrylates and methacrylates include aminomethyl, aminopropyl, aminobutyl and aminohexyl acrylates and methacrylates, dimethylaminoethyl acrylate, and dimethylaminoethyl methacrylate. Other suitable monomers include N-alkoxymethylacrylamide, and N-(butoxymethyl)acrylamide. Other ethylenically unsaturated monomers such as vinyl, styrene, α-methyl styrene, vinyl toluene, t-butyl styrene may also be included to provide the desired physical characteristics. A non-limiting example of a keto containing monomer includes diacetone acrylamide. Non-limiting examples of silane containing monomers, include alkoxysilane functional monomers, such as gamma-methylacryloxy propyl-trimethoxy silane, gamma-methylacryloxypropyl-triethoxy silane, gamma-methylacryloxypropyl-triisopropoxy silane, etc. A silanol functionality can be achieved by, for example, hydrolysis of a silane functional monomer, such as those identified herein. Particularly useful polymers are carboxylated styrene acrylate polymers.

Modified acrylics can also be used as the binder in the present invention. Non-limiting examples of these include polyester-modified acrylics or polyurethane-modified acrylics, as are well known in the art. An example of one polyester-modified acrylic is an acrylic polymer modified with δ-caprolactone, as described in U.S. Pat. No. 4,546,046. Polyurethane modified acrylics are also well known in the art, and an example is set forth in U.S. Pat. No. 4,584,354.

Polyesters having hydroxyl groups, acid groups, or amino groups as reactive functional groups can also be used as the binder in the present coating formulations. Such polyesters are well-known in the art, and may, for example, be prepared by the polyesterification of organic polycarboxylic acids (e.g., phthalic acid, hexahydrophthalic acid, adipic acid, maleic acid) or their anhydrides with organic polyols containing primary or secondary hydroxyl groups. Polyurethanes useful as the binder in the present invention can be selected from any polyurethanes known in the art to be useful as a binder in coatings. Polyurethanes suitable for use herein can be prepared, for example, by reacting polyisocyanate and polyol with an OH:NCO equivalent ratio of greater than 1:1, to obtain polyurethanes with terminal hydroxyl functionality. In this case, capping of the isocyanate occurs simultaneously with the synthesis of the polyurethane resin. Alternatively, polyurethane may be formed by reacting polyisocyanate and polyol with an OH:NCO ratio of less than 1:1. In this case, where excess isocyanate is used, the polyurethane having an unreacted isocyanate functionality is then reacted with a capping agent. Suitable capping agents include reactive alcohols or amines, and non-limiting examples of reactive alcohols or amines include trimethylolpropane, ethanolamine, diethanolamine, Solketal, diols, triols, or a mixture of diols and triols. It is preferred however, that any unreacted isocyanate be removed before using the polyurethane as the binder in the present invention.

Carbamate functional polymers are also suitable for use as the binder of the present invention. These polymers can, for example, be prepared from an acrylic monomer having a carbamate functionality in the ester portion of the monomer.

An alternative route for preparing a polymer useful as the binder in the present coating formulations is to react an already-formed polymer such as an acrylic polymer with another component to form a carbamate-functional group appended to the polymer backbone, as described in U.S. Pat. No. 4,758,632, the disclosure of which is incorporated herein by reference.

Another technique for preparing polymers useful as the binder in the present invention involves thermally decomposing urea (to give off ammonia and HNCO) in the presence of a hydroxy-functional acrylic polymer to form a carbamate-functional acrylic polymer.

Yet another technique for preparing a binder suitable for use in the present invention involves reacting the hydroxyl group of a hydroxylalkyl carbamate with the isocyanate group of an isocyanate-functional acrylic or vinyl monomer to form the carbamate-functional acrylic. Isocyanate-functional acrylics are known in the art and are described, for example in U.S. Pat. No. 4,301,257, and isocyanate vinyl monomers are also well-known in the art and include meta-isopropenyl-α-α-dimethylbenzyl isocyanate (m-TMI).

Still yet another technique for forming a binder suitable for use herein is to react the cyclic carbonate group on a cyclic carbonate-functional acrylic with ammonia to form a carbamate-functional acrylic. Cyclic carbonate-functional acrylic polymers are known in the art and are described, for example, in U.S. Pat. No. 2,979,514. A more difficult, but feasible way of preparing a polymer suitable for use as the binder in the present invention would be to transesterify an acrylate polymer with a hydroxyalkyl carbamate. Other methods of preparing the polymer can also be used.

In preferred embodiments, if the polymer used as the binder in the present invention contains reactive functional groups it is in the form of a latex, with the term “latex” being used herein in a broad sense to designate any, generally aqueous dispersion of a water-insoluble polymer, the polymer being present in the form of particles.

### Quaternary Ammonium Compounds—Counter-ions (Y)

The compositions and coatings, coating formulations, etc. of the present invention are preferably metal coupler free and contain at least one, in some embodiments only one, in some embodiments only two, and in other embodiments more that two, quaternary ammonium compounds having the formula described herein. The counter-ion of these quaternary ammonium compounds, Y, is selected from borate ions, phosphate ions, carbonate ions (CO₃⁻²), bicarbonate ions (HCO₃⁻), and carboxylate ions ([CO₂⁻]ₙR₅) In some embodiments, Y is a borate ion, or a phosphate ion, or a bicarbonate ion, or a carbonate ion or a carboxylate ion. In the case where two quaternary ammonium compounds are present, the counter ion of one of the quats is a bicarbonate ion and/or a carbonate ion, or a phosphate ion or a carboxylate ion, and the counter ion of the other quaternary ammonium compound is a borate ion.

Borate ions suitable for use herein include the dihydrogen borate ion, H₂BO₃⁻; the hydrogen borate ion, HBO₃⁻²; the borate ion, BO₃⁻³; the tetraborate ion, B₄O₇⁻²; the hydrogen tetraborate ion, HB₄O₇⁻; B₃O₅⁻; pentaborate, B₅O₈⁻²; and BO₂⁻. Thus, Y is suitably selected from H₂BO₃⁻; HBO₃⁻²; BO₃⁻³; B₄O₇⁻²; HB₄O₇⁻; B₃O₅⁻; B₅O₈⁻²; BO₂⁻. If Y is a borate ion, it is preferred that Y is BO₃⁻³ and m is 3.

Phosphate ions suitable for use herein include the phosphate ion, P₄⁻³; the hydrogen phosphate ion, HPO₄⁻²; the dihydrogen phosphate ion, H₂PO₄⁻; the diphosphate ion, P₂O₇⁻⁴, and the triphosphate ion, P₃O₁₀⁻⁵. Thus, Y is suitably selected from PO₄⁻³, HPO₄⁻², H₂PO₄⁻, P₂PO₇⁻⁴, P₃O₁₀⁻⁵, and PO₃⁻. If Y is a phosphate ion, it is preferred that Y is PO₄⁻³, and m is 3.

Carboxylate ions suitable for use herein have the general formula [CO₂C]ₙR₅, wherein n is an integer equal to or greater than 1 and R₅ is chosen from substituted, unsubstituted, saturated, or unsaturated alkyl groups containing in the range of from 1 to 25 carbon atoms. In some preferred embodiments, R₅ contains in the range of from about 10 to about 20 carbon atoms, in some embodiments in the range of from 10 to 12 carbon atoms, in other embodiments in the range of from 12 to 14 carbon atoms, in other embodiments in the range of from 12 to 14 carbon atoms, in other embodiments in the range of from 14 to 16 carbon atoms, and in still other embodiments in the range of from 16 to 18 carbon atoms

### Quaternary Ammonium Compounds—R₁, R₂, R₃ and R₄

The metal coupler free quats of the present invention contain four carbon chains, R₁, R₂, R₃ and R₄, attached to a nitrogen atom. In some embodiments, the four carbon chains of the quats according to the present invention are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. The alkyl and alkenyl groups are those that contain from 1 to 20 carbon atoms. In preferred embodiments, R₁ and R₂ are independently chosen from alkyl groups having from 1 to 3 carbon atoms, and R₃ and R₄ are independently chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3. In a more preferred embodiment, R₁ and R₂ are methyl groups and R₃ and R₄ are independently selected from unsubstituted alkyl groups containing from 8 to 14 carbon atoms. In one embodiment, one of R₃ or R₄ is an unsubstituted alkyl group containing from 8 to 10 carbon atoms, and one of R₃ or R₄ is an unsubstituted alkyl group containing from 12 to 14 carbon atoms.

In other embodiments, of the present invention, at least one, sometimes only one and in other embodiments only two, of the four carbon chains, i.e. R₁, R₂, R₃ and R₄, is selected from i) substituted or unsubstituted alkyl groups that contain from 13 to 16, preferably 14 to 16, more preferably 14, carbon atoms or ii) substituted or unsubstituted alkenyl groups that contain from 13 to 16, preferably 14 to 16, more preferably 14, carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups. These carbon chains can be saturated or unsaturated. It is preferred that the at least one of the four carbon chains is selected from saturated or unstaturated unsubstituted alkyl groups. In a particularly preferred embodiment, the at least one carbon chain is selected from unsaturated substituted or unsubstituted, preferably unsubstituted, alkyl groups containing from 13 to 16, preferably 14 to 16, more preferably 14, carbon atoms.

In this embodiment, at least two, in some embodiments only two, and in other embodiments three, of R₁, R₂, R₃ and R₄ are independently chosen from alkyl groups having from 1 to 4, preferably 1 to 3, in some embodiments 2 to 4, carbon atoms.

In this embodiment, it is also contemplated that one of R₁, R₂, R₃ and R₄ is selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. The alkyl and alkenyl groups are those that contain from 1 to 20 carbon atoms. In preferred embodiments, the one of R₁, R₂, R₃ and R₄ is chosen from 6 to 20 carbon atom-containing groups selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3. In some embodiments, it is selected from unsubstituted alkyl groups containing from 8 to 14 carbon atoms. In other embodiments, it is selected from unsubstituted alkyl group containing from 8 to 10 carbon atoms, and in other embodiments, it is selected from unsubstituted alkyl groups containing from 12 to 14 carbon atoms.

### Additives

In some embodiments, the coating formulation can also contain one, in some embodiments more than one, additive typically used in coating formulations. The additive and its amount used in the coating formulation of the present invention can be readily selected by one having ordinary skill in the art and knowledge of the desired characteristics of the coating, the binder, and the application of the coating formulation. Non-limiting examples of additives that can be used in the coating formulation of the present invention include solvents, thinners, pigments, extender pigments, coalescents, defoamers, thickeners, preservatives, surfactants, catalysts, hindered amine light stabilizers, ultraviolet light absorbers, rheology control additives, photoinitiators, and the like. In one embodiment, the coating formulation of the present invention is a coating formulation suitable for use in marine applications, and thus, the one, or in some embodiments more than one, additive is selected from additives commonly used in the marine paint industry, the amount being conventional in that industry. In this and other embodiments, it is preferred that the coating formulation be formaldehyde-free and isocyanate-free.

### Use of Coating Formulation

As stated above, the inventors hereof have discovered that quats can impart to the coating formulation several desired qualities. Thus, in one embodiment, the present invention relates to a surface having deposited thereon a coating formulation according to the present invention. “Surface” as used herein is used in its broadest sense and is meant to refer to ferrous or non-ferrous metal; wood; glass; fiberglass; other building and construction materials such as fiberboard, particle board, gypsum board, concrete, etc., and polystyrene-derived surfaces such as plastics, etc.

The method by which the coating formulation of the present invention is deposited onto the surface is not critical to the present invention, and the method can be selected from any method known in the art to be effective at depositing onto a surface a coating formulation. Non-limiting examples of suitable methods include spray coating, dip coating, flow coating, roll coating, curtain coating, vacuum coating, and the like.

### Alternative Embodiments

In one embodiment, compositions, coating, and coating formulations, etc., according to the present invention can comprise one, in some embodiments more than one, quaternary ammonium compounds having the formula:
wherein R₁, R₂, R₃, Y, and m are as described above, including preferred embodiments,

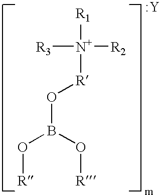

R′ is a hydrocarbon-group having from 1-10 carbon atoms, preferably 1-5, more preferably 1-3, and R′ and R′″ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups. Preferably R″ and R″′ are selected from unsubstituted alkyl groups having from 1-20 carbon atoms, preferably 1-15, and more preferably 6-14.

In another embodiment, the present invention relates compositions, coating, and coating formulations, etc., comprising a first and second quaternary ammonium compound. The first quaternary ammonium compound is characterized by the formula:

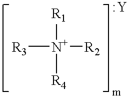

wherein the first quaternary ammonium composition is metal coupler free, m is as described above, and Y is selected from borates, as described above including preferred embodiments. In this embodiment, the four carbon groups, i.e., R₁, R₂, R₃ and R₄, of the first quaternary ammonium compound are selected from those described above, including prefered embodiments.

In this embodiment, the second quaternary ammonium compound is characterized by the formula:

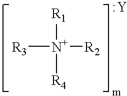

wherein the second quaternary ammonium composition is metal coupler free, m is as described above, and Y is selected from carbonates and/or bicarbonates, phosphates, carboxylates, and mixtures thereof, as described above including preferred embodiments. In this embodiment, the four carbon groups, i.e., R₁, R₂, R₃ and R₄, of the first quaternary ammonium compound are selected from those described above, including prefered embodiments.

The above description is directed to several embodiments of the present invention. Those skilled in the art will recognize that other embodiments, which are equally effective, could be devised for carrying out the spirit of this invention. It should also be noted that preferred embodiments of the present invention contemplate that all ranges discussed herein include ranges from any lower amount to any higher amount.

What is claimed:

1) A composition comprising:
a) at least one quaternary ammonium compound having the formula: 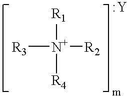
wherein:
i) Y is selected from H₂BO₃⁻; HBO₃⁻²; BO₃⁻³; B₄O₇⁻; HB₄O₇⁻; B₃O₅⁻; B₅O₈⁻²; BO₂⁻; PO₄⁻³, HPO₄⁻², H₂PO₄⁻, P₂O₇⁻⁴, P₃O₁₀⁻⁵, PO₃⁻; CO₃⁻²; HCO₃⁻; [CO₂₋]ₙR₅; and combinations thereof;
ii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) at least two of R₁, R₂, R₃ and R₄ are independently chosen from alkyl groups having from 1 to 4 carbon atoms;
iv) at least one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
v) n is an integer equal to or greater than 1 and R₅ is chosen from substituted, unsubstituted, saturated, or unsaturated alkyl groups containing from 1 to 25 carbon atoms; and
vi) m is 1, 2, 3, 4, or 5 depending on the selection of Y;
b) a binder; and
c) optionally at least one additive selected from solvents, thinners, pigments, extender pigments, coalescents, defoamers, thickeners, preservatives, surfactants, catalysts, hindered amine light stabilizers, ultraviolet light absorbers, rheology control additives, photoinitiators, and the like,
wherein said composition is i) metal coupler free, or ii) formaldehyde-free, or iii) isocyanate-free, or combinations of i)-iii).

2) The composition according to claim 1 wherein said binder is selected from i) linseed oil, ii) polyurethane, iii) polyvinyl acetate, or iv) alkyd, acrylic, or epoxy resins.

3) The composition according to claim 2 wherein iv) is selected from acrylic polymers, modified acrylic polymers, polyepoxides, polyesters, polycarbonates, polyurethanes, polyamides, polyimides, polysiloxanes, polycarbamates and mixtures thereof.

4) The composition according to claim 2 wherein iv) is selected from modified acrylics.

5) The composition according to claim 4 wherein said modified acrylics are selected from polyester-modified acrylics or polyurethane-modified acrylics.

6) The composition according to claim 2 wherein iv) is selected from polyesters having hydroxyl groups, acid groups, or amino groups as reactive functional groups.

7) The composition according to claim 1 wherein said binder is a polymer containing reactive functional groups, said reactive functional groups being in the form of a latex.

8) The composition according to claim 1 wherein said composition is a water-based formulation.

9) The coating formulation according to claim 1 wherein said composition is a solvent-based formulation.

10) The composition according to claim 4 wherein said binder is a water-soluble binder.

11) The composition according to any of claims 2 or 7-9 wherein said composition contains said optional additives.

12) The composition according to claim 2 wherein said composition comprises a) two or b) more than two quaternary ammonium compounds.

13) The composition according to claim 2 wherein said composition comprises more than two quaternary ammonium compounds, wherein the Y of one of said more than two quaternary ammonium compounds is selected from H₂BO₃⁻; HBO₃⁻; BO₃⁻³; B₄O₇⁻²; HB₄O₇⁻; B₃O₅⁻; B₅O₈⁻²; BO₂⁻ and combinations thereof, and the Y of the remainder of said more than two quaternary ammonium compounds is selected from PO₄⁻³, HPO₄⁻², H₂PO₄⁻, P₂O₇⁻⁴, P₃O₁₀⁻⁵, PO₃⁻; CO₃⁻²; HCO₃⁻; [CO₂⁻]ₙR₅; and combinations thereof.

14) The composition according to claim 2 wherein said composition comprises two quaternary ammonium compounds and the Y of one of the quaternary ammonium compounds of a) is selected from H₂BO₃⁻; HBO₃⁻²; BO₃⁻³; B₄O₇⁻²; HB₄O₇⁻; B₃O₅⁻; B₅O₈⁻²; BO₂⁻; and combinations thereof, and the Y of the other quaternary ammonium compound is selected from PO₄⁻³, HPO₄⁻², H₂PO₄⁻, P₂O₇⁻⁴, P₃O₁₀⁻⁵, PO₃⁻; CO₃⁻²; HCO₃⁻; [CO₂^{-]}ₙR₅, and combinations thereof.

15) The composition according to claim 1 wherein said composition comprises one quaternary ammonium compound and Y is selected from H₂BO₃⁻; HBO₃⁻²; BO₃⁻³; B₄O₇⁻²; HB₄O₇⁻; B₃O₅; B₅O₈⁻², and mixtures thereof.

16) The composition according to claim 15 wherein:
a) one of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) is saturated or unstaturated;
b) two of R₁, R₂, R₃ and R₄ are independently chosen from alkyl groups having from 1 to 4 carbon atoms; and
c) one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups.

17) The composition according to any of claims 12 or 14 wherein each of the quaternary ammonium compounds is characterized by:
a) one of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) saturated or unstaturated;
b) two of R₁, R₂, R₃ and R₄ are independently chosen from alkyl groups having from 1 to 4 carbon atoms; and
c) one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups.

18) The composition according to claim 15 wherein:
a) two of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) is saturated or unstaturated; and
b) two of R₁, R₂, R₃ and R₄ are independently chosen from alkyl groups having from 1 to 4 carbon atoms.

19) The composition according to any of claims 12 or 14 wherein each of the quaternary ammonium compounds is characterized by:
a) two of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) is saturated or unstaturated; and
b) two of R₁, R₂, R₃ and R₄ are independently chosen from alkyl groups having from 1 to 4 carbon atoms.

20) The composition according to claim 19 wherein a) is selected from unsaturated unsubstituted alkyl groups containing from 14 to 16 carbon atoms.

21) The composition according to any of claims 16 or 18 wherein a) is selected from unsaturated unsubstituted alkyl groups containing from 14 to 16 carbon atoms.

22) The composition according to claim 7 wherein a) is selected from unsaturated unsubstituted alkyl groups containing from 14 to 16 carbon atoms.

23) The composition according to claim 12 wherein one of the quaternary ammonium compounds of a) or b) is represented by formula (I): 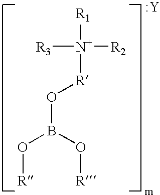
wherein formula (I) is metal coupler free; Y of formula (I) is selected from H₂BO₃⁻; HBO₃⁻²; BO₃⁻³; B₄O₇⁻; HB₄O₇⁻; B₃O₅⁻; B₅O₈⁻²; and BO₂⁻; R′ is a hydrocarbon group having from 1-10 carbon atoms and R″ and R″′ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and R₁, R₂, and R₃ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3, depending on the selection of Y.

24) The composition according to any of claims 1, 2, 12, 15, or 16 wherein said composition contains in the range of from about 0.01 wt. % to about 10 wt. %, of said at least one quaternary ammonium compound, based on the total weight of the composition.

25) The composition according to claim 19 wherein said composition contains in the range of from about 0.01 wt. % to about 1 wt. %, of said quaternary ammonium compound, based on the total weight of the composition.

26) The composition according to claim 18 wherein said composition contains in the range of from about 0.01 wt. % to about 1 wt. %, of said quaternary ammonium compound, based on the total weight of the composition.

27) The composition according to claim 17 wherein said composition contains in the range of from about 0.001 wt. % to about 10 wt. %, of said at least one quaternary ammonium compound, based on the total weight of the composition.

28) The composition according to claim 24 wherein said composition is capable of imparting to a surface at least one of the following properties: i) fungicidal properties, ii) mildewcidal properties, iii) biocidal properties, and iv) properties that prevent or inhibit the growth of marine life such as barnacles, etc.

29) The composition according to claim 27 wherein said composition is capable of imparting to a surface at least one of the following properties: i) fungicidal properties, ii) mildewcidal properties, iii) biocidal properties, and iv) properties that prevent or inhibit the growth of marine life such as barnacles, etc

30) A composition comprising:
a) at least one first quaternary ammonium compound having the formula: 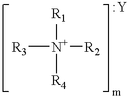
wherein the at least one first quaternary ammonium compound is characterized by:
i) Y is selected from H₂BO₃⁻; HBO₃⁻²; BO₃⁻³; B₄O₇⁻²; HB₄O₇⁻; B₃O₅⁻; B_{5O}₈⁻²; BO₂⁻; and mixtures thereof
ii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) m is 1, 2, or 3, depending on the selection of Y;
b) at least one second quaternary ammonium compound having the formula: 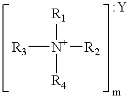
wherein said at least one second quaternary ammonium compound is characterized by:
i) Y is selected from CO₃⁻²; HCO₃⁻; PO₄⁻³, HPO₄⁻³, H₂PO₄⁻, P₂O₇⁻⁴, P₃O₁₀⁻⁵, PO₃⁻; [CO₂⁻]ₙR₅; and mixtures thereof;
ii) R₁, R₂, R₃ and R₄ are selected from i) substituted or unsubstituted alkyl groups or ii) substituted or unsubstituted alkenyl groups, wherein if i) or
ii) is substituted, they have one or more substituent groups selected from aryl, heterocyclyl, hydroxyl, ester, benzyl, carboxyl, halo, nitro, cyano, alkoxy or oxo groups;
iii) n is an integer equal to or greater than 1 and R₅ is chosen from substituted, unsubstituted, saturated or unsaturated alkyl groups containing from 1 to 25 carbon atoms; and
iv) m is 1, 2, 3, 4,or 5;
c) a binder; and
d) optionally at least one additive selected from solvents, thinners, pigments, extender pigments, coalescents, defoamers, thickeners, preservatives, surfactants, catalysts, hindered amine light stabilizers, ultraviolet light absorbers, rheology control additives, photoinitiators, and the like,
wherein said composition is i) metal coupler free, or ii) formaldehyde-free, or iii) isocyanate-free, or combinations of i)-iii).

31) The composition according to claim 30 wherein said binder is selected from i) linseed oil, ii) polyurethane, iii) polyvinyl acetate, or iv) alkyd, acrylic, or epoxy resins.

32) The composition according to claim 31 wherein iv) is selected from acrylic polymers, modified acrylic polymers, polyepoxides, polyesters, polycarbonates, polyurethanes, polyamides, polyimides, polysiloxanes, polycarbamates and mixtures thereof.

33) The composition according to claim 31 wherein iv) is selected from modified acrylics.

34) The composition according to claim 33 wherein said modified acrylics are selected from polyester-modified acrylics or polyurethane-modified acrylics.

35) The composition according to claim 31 wherein iv) is selected from polyesters having hydroxyl groups, acid groups, or amino groups as reactive functional groups.

36) The composition according to claim 30 wherein said binder is a polymer containing reactive functional groups, said reactive functional groups being in the form of a latex.

37) The composition according to claim 30 wherein said composition is a water-based formulation.

38) The coating formulation according to claim 30 wherein said composition is a solvent-based formulation.

39) The composition according to claim 33 wherein said binder is a water-soluble binder.

40) The composition according to any of claims 31 or 36-38 wherein said composition contains said optional additives.

41) The composition according to claim 31 wherein said composition comprises one first quaternary ammonium compound.

42) The composition according to claim 31 wherein said at least one first quaternary ammonium compound is characterized by:
a) one of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) saturated or unstaturated;
b) two of R₁, R₂, R₃ and R₄ are independently chosen from alkyl groups having from 1 to 4 carbon atoms; and
c) one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl₅ ester, benzyl, carboxyl, halo, nitro, cyano, alkoxy or oxo groups. or
a) two of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) is saturated or unstaturated; and
b) two of R₁, R₂, R₃ and R₄ are independently chosen from alkyl groups having from 1 to 4 carbon atoms.

43) The composition according to claim 41 wherein said one first quaternary ammonium compound is characterized by:
a) one of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) saturated or unstaturated;
b) two of R₁, R₂, R₃ and R₄ are independently chosen from alkyl groups having from 1 to 4 carbon atoms; and
c) one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups.
or
a) two of R₁, R₂, R₃ and R₄ is selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups, wherein i) is saturated or unstaturated; and
b) two of R₁, R₂, R₃ and R₄ are independently chosen from alkyl groups having from 1 to 4 carbon atoms.

44) The composition according to claim 31 wherein one of said at least one first quaternary ammonium compound or one of said at least one second quaternary ammonium compound is represented by formula (I): 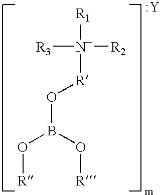
wherein formula (I) is metal coupler free; Y of formula (I) is selected from H₂BO₃⁻; HBO₃⁻²; BO₃⁻³; B₄O₇⁻²; HB₄O₇⁻; B₃O₅⁻; B₅O₈⁻²; and BO₂⁻R′ is a hydrocarbon group having from 1-10 carbon atoms and R″ and R″′ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and R₁, R₂, and R₃ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3, depending on the selection of Y.

45) The composition according to claim 41 wherein one of said one first quaternary ammonium compound or one of said at least one second quaternary ammonium compound is represented by formula (I): 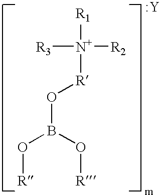
wherein formula (I) is metal coupler free; Y of formula (I) is selected from H₂BO₃⁻; HBO₃⁻²; BO₃⁻³; B₄O₇⁻²; HB₄O₇⁻; B₃O₅⁻; B₅O₈⁻²; R′ is a hydrocarbon group having from 1-10 carbon atoms and R″ and R″′ are independently selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and R₁, R₂, and R₃ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups; and m is 1, 2, or 3, depending on the selection of Y.

46) The composition according to any of claims 31, 32, 36, or 41-45 wherein said composition contains in the range of from about 0.001 wt.% to about 10 wt. %, of said at least one quaternary ammonium compound, based on the total weight of the composition.

47) The composition according to claim 46 wherein said composition is capable of imparting to a surface at least one of the following properties: i) fungicidal properties, ii) mildewcidal properties, iii) biocidal properties, and iv) properties that prevent or inhibit the growth of marine life such as barnacles, etc.

48) A process for imparting desired properties to a surface comprising depositing onto a surface a coating formulation comprising:
A)
a) at least one quaternary ammonium compound having the formula: 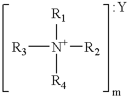
wherein:
i) Y is selected from H₂BO₃⁻; HBO₃⁻²; BO₃⁻³; B₄O₇⁻²; HB₄O₇₋; B₃O₅⁻; B₅O₈⁻²; BO₂⁻; PO₄⁻³, HPO₄⁻², H₂PO₄⁻, P₂P₇⁻⁴, P₃O₁₀⁻⁵, PO₃⁻; CO₃⁻²; HCO₃⁻; [CO₂⁻]ₙR₅; and combinations thereof;
ii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) at least two of R₁, R₂, R₃ and R₄ are independently chosen from alkyl groups having from 1 to 4 carbon atoms;
iv) at least one of R₁, R₂, R₃ and R₄ is chosen from i) substituted or unsubstituted alkyl groups that contain from 1 to 20 carbon atoms or ii) substituted or unsubstituted alkenyl groups that contain from 1 to 20 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
v) n is an integer equal to or greater than 1 and R₅ is chosen from substituted, unsubstituted, saturated, or unsaturated alkyl groups containing from 1 to 25 carbon atoms; and
vi) m is 1, 2, 3, 4, or 5 depending on the selection of Y;
b) a binder; and
c) optionally at least one additive selected from solvents, thinners, pigments, extender pigments, coalescents, defoamers, thickeners, preservatives, surfactants, catalysts, hindered amine light stabilizers, ultraviolet light absorbers, rheology control additives, photoinitiators, and the like,
or
B)
a) at least one first quaternary ammonium compound having the formula: 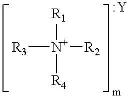
wherein the at least one first quaternary ammonium compound is characterized by:
i) Y is selected from H₂BO₃⁻; HBO₃⁻²; BO₃⁻³; B₄O₇⁻; HB₄O₇⁻; B₃O₅⁻; B₅O₈⁻²; BO₂⁻; and mixtures thereof
ii) at least one of R₁, R₂, R₃ and R₄ are selected from i) substituted or unsubstituted alkyl groups that contain from 13 to 16 carbon atoms or ii) substituted or unsubstituted alkenyl groups that contain from 13 to 16 carbon atoms, wherein if i) or ii) is substituted, they have one or more substituent groups selected from aryl, heterocyclyl, hydroxyl, ester, benzyl, carboxyl, halo, nitro, cyano, alkoxy or oxo groups;
iii) m is 1, 2, or 3, depending on the selection of Y;
b) at least one second quaternary ammonium compound having the formula: 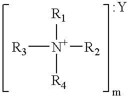
wherein said at least one second quaternary ammonium compound is characterized by:
iv) Y is selected from CO₃⁻²; HCO₃⁻; PO₄⁻³, HPO₄⁻², H₂PO₄⁻, P₂O₇⁻⁴, P₃O₁₀⁻⁵, PO₃⁻; [CO₂⁻]ₙR₅; and mixtures thereof;
v) R₁, R₂, R₃ and R₄ are selected from i) substituted or unsubstituted alkyl groups or ii) substituted or unsubstituted alkenyl groups, wherein if i) or ii) is substituted, they have one or more substituent groups selected from aryl, heterocyclyl, hydroxyl, ester, benzyl, carboxyl, halo, nitro, cyano, alkoxy or oxo groups;
vi) n is an integer equal to or greater than 1 and R₅ is chosen from substituted, unsubstituted, saturated or unsaturated alkyl groups containing from 1 to 25 carbon atoms; and
vii) m is 1, 2, 3, 4, or 5;
c) a binder; and
d) optionally at least one additive selected from solvents, thinners, pigments, extender pigments, coalescents, defoamers, thickeners, preservatives, surfactants, catalysts, hindered amine light stabilizers, ultraviolet light absorbers, rheology control additives, photoinitiators, and the like,
wherein A) or B) are i) metal coupler free, or ii) formaldehyde-free, or iii) isocyanate-free, or combinations of i)-iii).

49) The process according to claim 48 wherein said desired properties include at least one of the following properties: i)fungicidal properties, ii)mildewcidal properties, iii)biocidal properties, and iv)properties that prevent or inhibit the growth of marine life such as barnacles, etc.

50) The process according to claim 48 wherein said desired properties include at least two of the following properties: i) fungicidal properties, ii) mildewcidal properties, iii) biocidal properties, and iv) properties that prevent or inhibit the growth of marine life such as barnacles, etc.

51) The process according to claim 48 wherein said desired properties substantially all of the following properties: i) fungicidal properties, ii) mildewcidal properties, iii) biocidal properties, and iv) properties that prevent or inhibit the growth of marine life such as barnacles, etc.

52) The process according to any of claims 48-51 wherein said surface is ferrous or non-ferrous metal; wood; glass; fiberglass; other building and construction materials such as fiberboard, particle board, gypsum board, concrete, etc., and polystyrene-derived surfaces such as plastics, etc.

53) The process according to claim 52 wherein said coating formulation is a marine paint.

54) The process according to claim 48 wherein said coating formulation is deposited onto said surface by a method selected from spray coating, dip coating, flow coating, roll coating, curtain coating, vacuum coating, and the like.

55) The process according to claim 52 wherein said coating formulation is deposited onto said surface by a method selected from spray coating, dip coating, flow coating, roll coating, curtain coating, vacuum coating, and the like.
